(19) United States
(12) Patent Application Publication
(10) Pub. No.: US 2003/0221009 A1
(43) Pub. Date: Nov. 27, 2003

(54) Dual mode peer-to-peer link establishment for instant message video

(75) Inventors: Aaron Standridge, Newark, CA (US); John J. Feldis III, Menlo Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/153,828

(22) Filed: May 21, 2002

(51) Int. Cl. G06F 15/16

(52) U.S. Cl. 709/227

(57) ABSTRACT

An automatic, seamless connection for transmitting video regardless of the firewall configurations. In particular, the invention marries the peer-to-peer connection with a reflector, web page configuration. The producer of a video sends its IP address to a recipient. (1) The recipient then attempts to establish a peer-to-peer connection using the producer IP address. If this is unsuccessful, the recipient passes its IP address to a designated web server, which the producer will contact after it notices that the recipient has not established a connection. The producer retrieves the recipient IP address from the designated web server and (2) attempts to establish a peer-to-peer connection using the recipient IP address. If this is unsuccessful, (3) a reflector arrangement is used by the producer sending video to a reflector server. The recipient, upon noticing that the producer has not be able to establish a peer-to-peer connection, also accesses the reflector server with the IP address previously provided by the producer in the original transmission.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to peer-to-peer video transmission in conjunction with instant messenger services using the Internet.

An early instant messenger (IM) program was ICQ. Today other major programs are AIM (AOL IM) and MSN® Messenger (from Microsoft). These instant messenger services work by loading a client program on a user's computer. When the user logs on, the client program calls the IM server over the Internet and lets it know that the user is online. The client program sends connection information to the server, in particular the IP (Internet Protocol) address and port and the names of the user's buddies. The server then sends connection information back to the client program for one's of those buddies who are currently online. The user can then click on one of the buddies and send a peer-to-peer message without going through the IM server. Each IM service has its own proprietary protocol, that is different from the Internet HTTP (HyperText Transport Protocol).

Obtaining the correct IP address is critical for a peer-to-peer communication. Many IP addresses, especially for dial-up home machines, are assigned by the service provider for each session. Thus, a particular computer can have a different IP address each time the user logs on. Thus, there is a need to get the current IP address for a peer-to-peer transmission. An additional difficulty is caused by firewalls, which are typical in most businesses. The firewall is a filter between the computer or local area network (LAN) and the Internet. Typically, the firewall includes a NAT (Network Address Translation) service which enables the LAN to use one set of IP addresses for internal traffic and a second set of IP address for external traffic. Thus, for a peer-to-peer transmission, the external address, which may be different from the computer's individual address, needs to be known. In addition, such firewalls may limit the ability of a computer behind the firewall to establish a peer-to-peer connection by limiting outgoing connections.

Peer-to-peer architectures include the widely-known Napster and Gnutella. These services allow the swapping or sharing of files, in particular MP3 sound recording files. In the Gnutella protocol, a particular computer will try to establish a direct peer-to-peer connection with another computer. Since Gnutella runs over HTTP, two sites can communicate even if one is behind a firewall. However, if a client behind a firewall is asked to serve up a file, it may not be able to do so. This can be handled by using a Push command instead of a Get command to initiate the transfer from the other direction. However, if both clients are behind firewalls, file sharing may not be possible.

The transmission of video over the Internet takes many forms. Some simply use webcams as basically web servers, with their own URL which allows them to be accessed over the Internet as any web page can be accessed. However, a number of products use a peer-to-peer connection for video.

Net Meeting™, a Microsoft product, establishes a peer-to-peer connection similar to an instant messenger connection. However, in addition to text, video can be transmitted using the unique protocol. This software requires that both sides have the Net Meeting software, and also requires the initiator to either type in the IP address of the other person, or to access a directory of IP addresses, such as the Microsoft Internet Directory which includes the Internet Locator Service (ILS).

Another product called Buddy Vision™ sends pictures through the chat window of an IM service. This requires that the Buddy Vision client software by constantly updated to keep up with changes in the IM software to allow it to communicate with the IM software. Buddy Vision also offers a video conferencing feature, but this requires the downloading of separate software on both sides, similar to Net Meeting.

Another product called Eyeball Chat™ provides software which links to a server and downloads a video player plug-in. Video is then sent as a file from the producer to the recipient, which then uses the video player to play the video. This does not provide the same real-time capabilities as other products.

Another product is Spot Life™, in which a producer of a video loads the video to a web server, where it can be accessed using a browser by multiple recipients. This is an alternative to a peer-to-peer transmission.

Another alternative to a peer-to-peer connection is a reflector server. This technique is typically used when information is desired to be transmitted to multiple recipients. The producer of the video or other information uploads it to a reflector web server. The reflector server then can be accessed by the various recipients in the same manner as a normal web page would be accessed.

### BRIEF SUMMARY OF THE INVENTION

The present invention provides an automatic, seamless connection for transmitting video regardless of the firewall configurations. In particular, it marries the peer-to-peer connection with a reflector, web page configuration. The producer of a video sends its IP address to a recipient. (1) The recipient then attempts to establish a peer-to-peer connection using the producer IP address. If this is unsuccessful, the recipient passes its IP address to a designated web server, which the producer will contact after it notices that the recipient has not established a connection. The producer retrieves the recipient IP address from the designated web server and (2) attempts to establish a peer-to-peer connection using the recipient IP address. If this is unsuccessful, (3) a reflector arrangement is used by the producer sending video to a reflector server. The recipient, upon noticing that the producer has not been able to establish a peer-to-peer connection, also accesses the reflector server with the IP address of the reflector server previously provided by the producer in the original transmission.

From a user standpoint, the recipient of video simply clicks on the URL appearing in its IM chat box and the video appears. Whether a peer-to-peer arrangement is used starting from either side, or a reflector arrangement is used, it is transparent to the user. In one embodiment, the original transmission of the producer IP to the recipient also includes the URL of the designated web server. Upon clicking on the URL by the recipient, the recipient's browser is automatically activated, just as it would be for clicking on any URL. The browser then goes to the web page of the designated web server, transmitting with it the producer IP address. The web server then produces a web page which includes the producer IP address it receives, and also a script for performing the steps necessary to establish the connection by first trying peer-to-peer, in both directions if necessary, and then using a reflector server, whose address is also provided with the original URL. The script includes a viewer for directly viewing the video from the producer. Both an ATL viewer and a JPEG viewer can be provided, with the appropriate one being used depending upon the user's computer configuration.

For a further understanding of the nature and advantages of the present invention, reference should be made to the following description taken in conjunction with the accompanying drawings.

### BRIEF DESCRIPTION OF THE DRAWINGS

FIG. 1 is a block diagram of a typical computer on which a client according to the present invention can run.

FIG. 2 is a diagram of the user interface on the producer display.

FIG. 3 is a block diagram of the various connections over the Internet in an embodiment of the invention.

FIG. 4 is a diagram illustrating the initiation of sending video by the producer in an embodiment of the invention.

FIG. 5 is a diagram of the user interface on the recipient display.

FIG. 6 is a diagram of the initial steps taken by the recipient in communication with the Q server.

FIG. 7 is a diagram of the contents of the web page downloaded to the recipient from the Q server.

FIG. 8 is a diagram illustrating a peer-to-peer attempt by the recipient.

FIG. 9 is a diagram of the use of a reflector server.

FIG. 10 is a diagram illustrating the addresses used in the peer-to-peer attempt and the reflector connection in one embodiment of the invention.

### DETAILED DESCRIPTION OF THE INVENTION

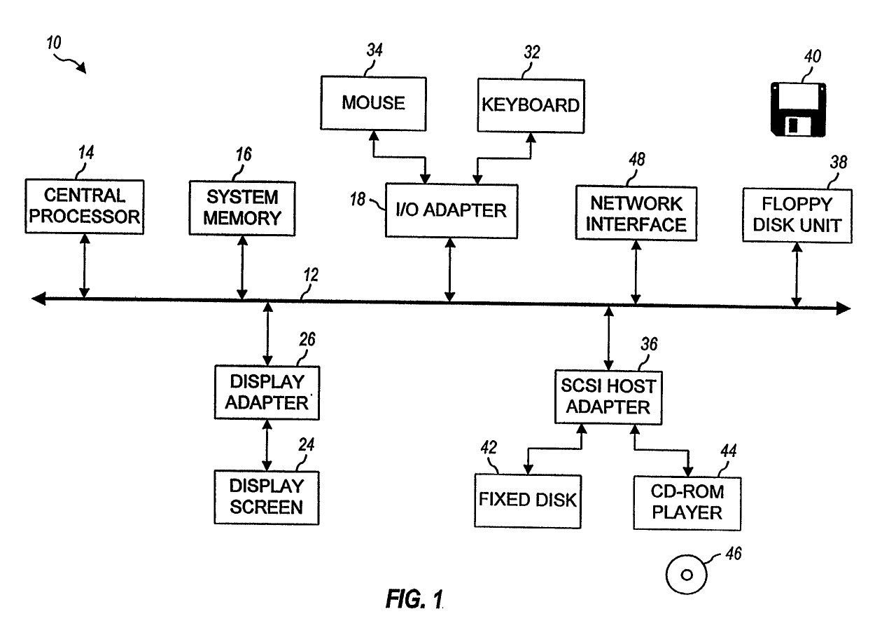

First, a description is presented of a typical computer configuration on which the software of the present invention will run in one embodiment. FIG. 1 depicts a block diagram of a host computer system 10 suitable for implementing the present invention. Host computer system 10 includes a bus 12 which interconnects major subsystems such as a central processor 14, a system memory 16 (typically RAM), an input/output (I/O) adapter 18, an external device such as a display screen 24 via display adapter 26, a keyboard 32 and mouse 34 via I/O adapter 18, a SCSI host adapter 36, and a floppy disk drive 38 operative to receive a floppy disk 40. SCSI host adapter 36 may act as a storage interface to a fixed disk drive 42 or a CD-ROM player 44 operative to receive a CD-ROM 46. Fixed disk 44 may be a part of host computer system 10 or may be separate and accessed through other interface systems. A network interface 48 may provide a direct connection to a remote server via a telephone link or to the Internet via a POP (point of presence). Many other devices or subsystems (not shown) may be connected in a similar manner.

Also, it is not necessary for all of the devices shown in FIG. 1 to be present to practice the present invention, as discussed below. The devices and subsystems may be interconnected in different ways from that shown in FIG. 1. The operation of a computer system such as that shown in FIG. 1 is readily known in the art and is not discussed in detail in this application. Code to implement the present invention may be operably disposed or stored in computer-readable storage media such as system memory 16, fixed disk 42, CD-ROM 46, or floppy disk 40.

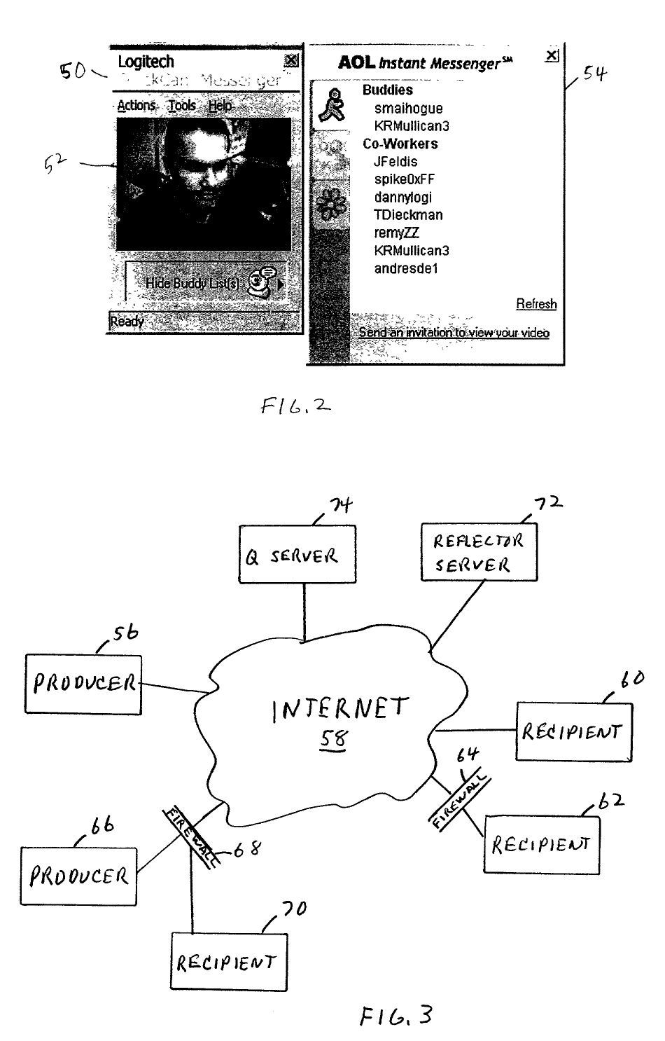

FIG. 2 is a diagram of one embodiment of the user interface display on the display of a producer of video. Box 50 provides a view of the user video 52, while box 54 shows the buddies that have been harvested from a separate instant messenger program such as AIM, ICQ, MSN.

FIG. 3 illustrates the connections over the Internet according to an embodiment of the invention. The term “producer” is used to refer to the generator of the video, while the term “recipient” is used to refer to the person who receives the video. A first example of a producer 56 is connected directly to the Internet 58. From there, it can be routed to a recipient 60 which is directly connected to the Internet, or to a recipient 62 which is connected to the Internet through a firewall 64. Alternately, a producer 66 could be located behind a firewall 68. A recipient 70 is shown behind the same firewall 68.

A peer-to-peer relationship can be established in most of these arrangements. Where neither the producer nor the recipient are behind a firewall, or where only one of them is behind a firewall, a peer-to-peer connection can be established. Alternately, if both the producer and the recipient are behind the same firewall, a peer-to-peer connection can be established. However, if both the producer and the recipient are behind firewalls, such as producer 66 and recipient 62, a peer-to-peer connection may not be possible. In this instance, a reflector server 72 would need to be used. The establishment of the peer-to-peer connection is facilitated by a Q server 74, as will be described below.

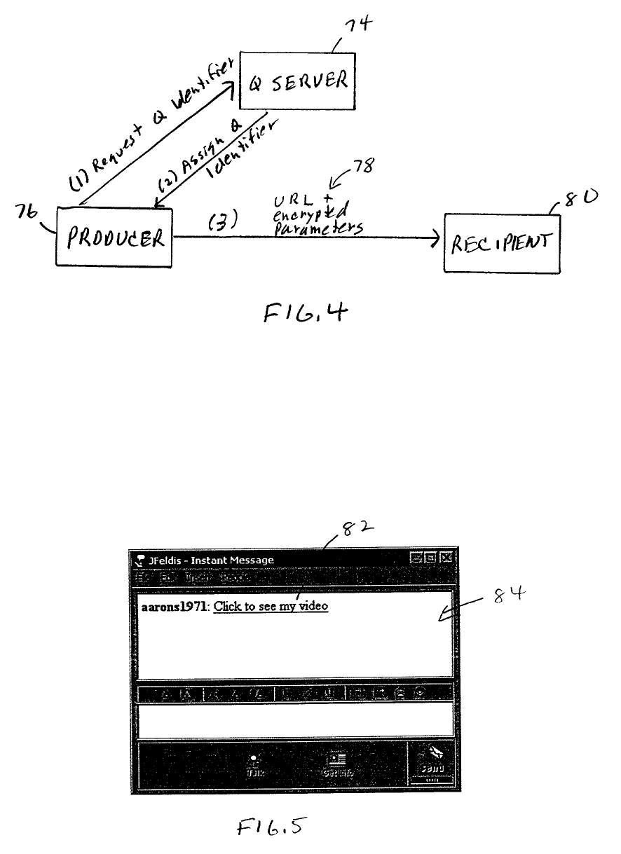

FIG. 4 illustrates the sending of an invitation to the video by a producer 76. Producer 76 will do this by running a client softward program previously downloaded, provided on a disk, or provided in a camera. (1) First, a request is sent to Q server 74 to allocate a small amount of memory for a connection attempt, and to assign an identifier referred to as a Q identifier. In addition, the producer sends its IP address information along with an encryption key to enable the Q server to decrypt a subsequently received encrypted message. (2) The Q server then sends back an acknowledgment of the assignment of the memory along with the Q identifier. (3) The producer then sends a URL message 78 to recipient 80.

The URL message will consist of the following items:

Local IM buddy name.

“Q” identifier.

Local IP address of the machine running the client (Producer).

Local IP address of the machine running the client (as seen from a server). This will further assist in connection issues.

Remote buddy-name to whom the URL is being sent.

Session identifier. When an URL message is sent, a session identifier is generated which allows the client to control how long to wait for a connection to be established. This session identifier will be passed to the client during the connection protocol. This allows the client to either access or deny an attempt for a remote client to establish a connection.

Reflector IP address.

The URL sent by the client will be in the following form:

HTTP://www.logitech.com/<product_name>/viewer.htm?A,B,C,D,E,F,G

Where...

A=Local IM buddy name. This name will indicate the “screen name” of the buddy sending the message. Example: aarons1971

B=“Q” identifier. This name will the “Q” identifier. This parameter will be up to 15 characters long. Example: 8a7848df87e091123

C=Local IP address. This parameter identifies the local IP address of the machine sending the URL link. Note: This parameter is encrypted: Example: 88271y481947147dsf345

D=Local IP address. This parameter identifies the IP address of the machine sending the URL link as seen from a server. Note: This parameter is encrypted: Example: 2661171y481947147dsf345

E=Remote buddy name. This parameter identifies name of the remote buddy to whom this message is being sent. Example: JFeldis

F=Session identifier. This parameter identifies a session identifier, which is used internally by the client application and the ATL viewer control. Example: 13

G=Reflector server IP address.

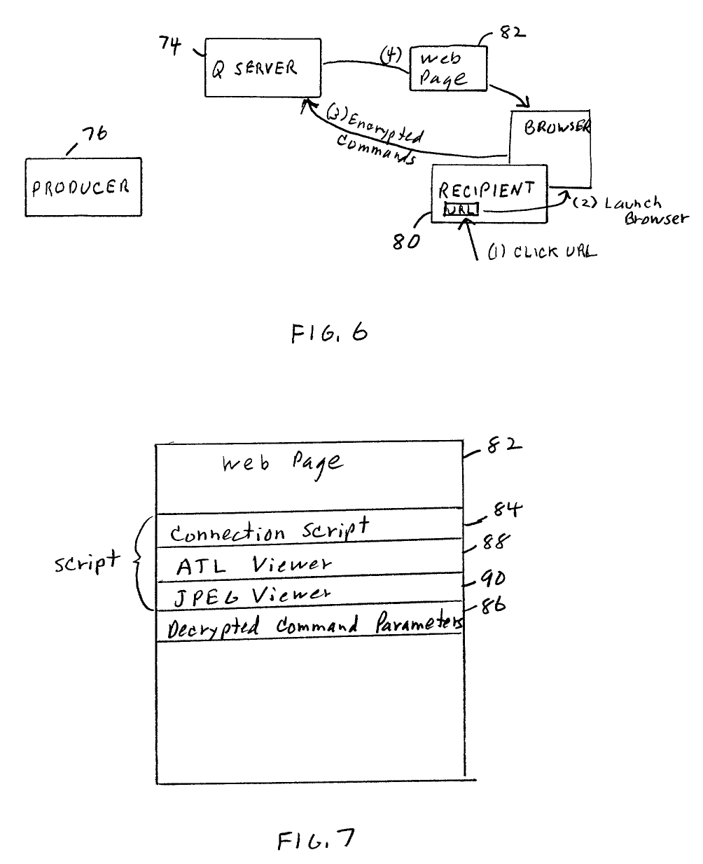

The URL message uses the IM chat mechanism for the transmission, with the URL message appearing to the recipient as a message “Click to see my video” 82 shown in a chat window 84 of a recipient's IM window as shown in FIG. 5. When the user clicks on message 82, the steps set forth in FIG. 6 are initiated.

As FIG. 6 shows, (1) the user clicks on the URL. (2) The user's browser is launched, if it is not already active, as it would for any clicking on a URL. The browser then sends (3) the URL message to Q server 74. This includes the producer IP address, the Q identifier, and any other information in the URL message. Preferably, at least the producer IP address is encrypted.

Q server 74 decrypts the IP address of the producer, and (4) sends back a web page 82.

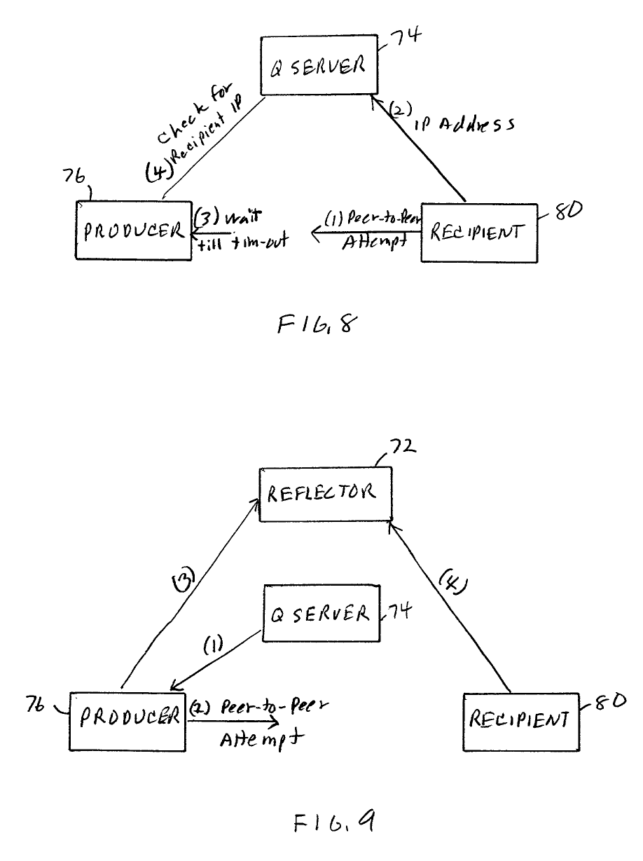

FIG. 7 illustrates in simplified format the contents of web page 82. The web page includes connection script 84, which is a small applet for establishing the peer-to-peer connection with producer 76. It also includes the decrypted command parameters 86, in particular the producer IP address. Also included are video viewers, such as an ATL viewer 88 and/or a JPEG viewer 90. In one embodiment, ATL 88 is included in the web page first sent to the user, but if the user's machine is incapable of supporting the ATL viewer, a refresh request is sent back to the Q server, which then provides an updated web page with a JPEG viewer 90.

As shown in FIG. 8, recipient 80 then (1) attempts to make a peer-to-peer connection with producer 76. If recipient 80 is behind a firewall, this may be unsuccessful because outgoing traffic is blocked. Recipient 80, upon determining that its connection attempt is unsuccessful, will (2) sent its recipient IP address to Q server 70, for storage in the designated small amount of memory indicated by the Q identifier. If there is no peer-to-peer connection established, producer 76 determines there is no connection at the end (3) of a timeout period. Producer 76 monitors the designated port from the URL message, and if it does not receive the peer-to-peer connection from recipient 80, it will then (4) contact Q server 74 to see if the recipient has provided its IP address to the Q server.

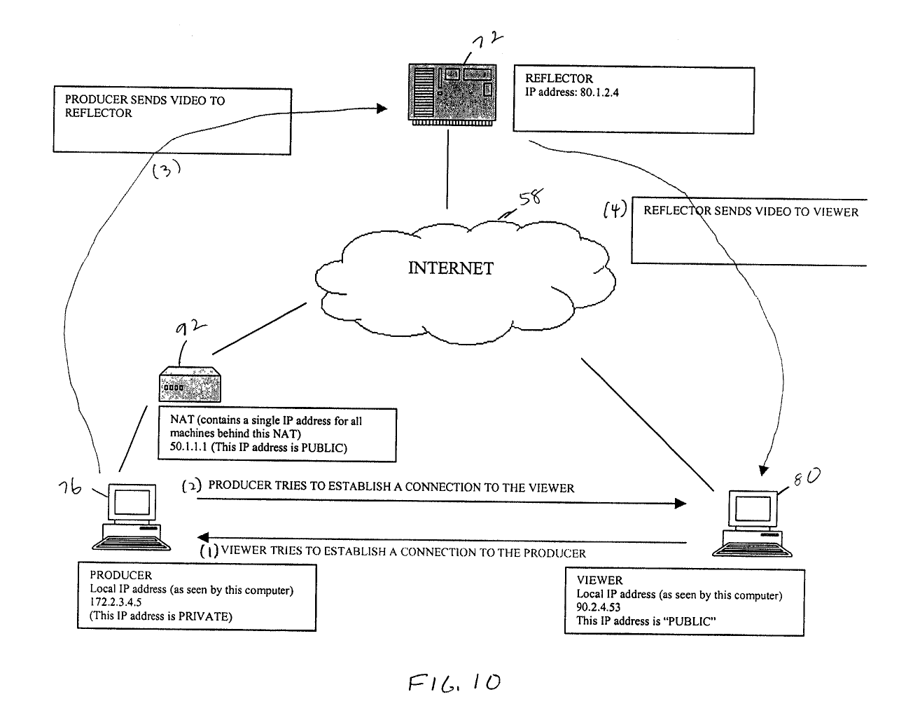

As shown in FIG. 9, Q server 74 (1) will provide the recipient IP address to producer 76. (2) Producer 76 will then attempt the peer-to-peer connection using the recipient IP address. If this is unsuccessful, due, for instance, to producer 76 also being behind a firewall, the producer will then (3) send its video to a reflector server 72. Recipient 80, after a timeout period, will realize that the peer-to-peer attempt by producer 76 was unsuccessful, and will (4) contact reflector server 72 to view the video using the reflector URL previously provided in the original URL message.

FIG. 10 is a diagram illustrating examples of the different IP addresses. As shown in the example of FIG. 10, producer 76 has a local IP address which is private, but also has a public IP address associated with the network at a firewall 92. As illustrated, (1) the viewer first tries to establish a connection to the producer as described above. (2) If this is unsuccessful, the producer obtains the recipient IP address from the Q server, and it tries to establish a connection to the recipient. If this is unsuccessful (3) the producer sends its video to the reflector 72, and reflector 72 (4) sends it video to the recipient 80.

All of the above-described connection operation is transparent to the users. The sender simply selects a buddy and clicks on sending video. The recipient simple clicks on viewing the video and the video appears in a window of the web page from the Q server. The recipient doesn't know whether this was accomplished by its computer connecting to the producer, by the producer subsequently connecting to it after a first failure, or through the user of a reflector server. Accordingly, the present invention provides an automatic, seamless method for establishing a connection which is user-friendly. In addition, by piggybacking on the IM chat message to send the invitation, but by using a standard browser web page to provide the video, the present invention can work with different types of IM message protocols. In addition, since the connection script and the viewer script are both embedded in the web page from the Q server, there is no need for a user to have a particular program or to download a program in order to view the video.

As will be understood by those of skill in the art, the present invention may be embodied in other specific forms without departing from the essential characteristics thereof. For example, the producer might send only its public IP address, and not its private IP address. In another example, instead of using timeouts to move to the next step, an affirmative message could be sent from the recipient to the producer or vice versa using the IM chat window to indicate that the connection was unsuccessful. This message could be made invisible to the user, simply to cause the program on the other side to initiate the next step. Accordingly, the foregoing description is intended to be illustrative, but not to limit, the scope of the invention, which is set forth in the following claims.

What is claimed is:

1. A method for establishing a peer-to-peer connection between two computers using an instant messenger transmission, comprising:
sending a producer IP address from a producer of video to a remote recipient via an instant message;
making, at said recipient, an attempt to establish a peer-to-peer connection with said producer using said producer IP address;
if said attempt is unsuccessful, transmitting a recipient IP address of said recipient to a designated web server;
said producer contacting said designated web server to obtain said recipient IP address if a peer-to-peer connection is not established by said recipient within a predetermined time after the producer IP address is send to said recipient;
said producer attempting to establish a peer-to-peer connection with said recipient using said recipient IP address;
said producer sending video to a reflector server for viewing by said recipient if the attempt to establish a peer-to-peer connection using said recipient IP address is unsuccessful; and
said recipient contacting said reflector using an address sent by said producer to contact said reflector if said producer does not establish a peer-to-peer link.

2. The method of claim 1 further comprising:
sending a URL of said designated web server to said recipient along with said producer IP address in said instant message;
activating a browser at said recipient upon the clicking on said URL and transmitting said producer IP address to said designated web server;
transmitting a web page from said designated web server to said recipient, said web page including said producer IP address and a script for performing steps to establish a connection with said producer using said producer IP address;
establishing a connection with said producer using said producer IP address;
displaying video from said producer in a window of said web page at said recipient.

3. The method of claim wherein said script includes a video viewer for viewing said video from said producer.

4. The method of claim 3 wherein said video viewer comprises an ATL viewer and a JPEG viewer.

5. The method of claim 1 wherein said producer IP address includes an NAT address.

6. The method of claim 1 wherein said producer IP address includes a port.

7. A method for establishing a peer-to-peer connection between two computers using an instant messenger transmission, comprising:
sending a URL of a designated web server to a recipient along with a producer IP address in said instant message;
activating a browser at said recipient upon the clicking on said URL and transmitting said producer IP address to said designated web server;
transmitting a web page from said designated web server to said recipient, said web page including said producer IP address and a script for performing steps to establish a connection with said producer using said producer IP address;
establishing a connection with said producer using said producer IP address; and
displaying video from said producer in a window of said web page at said recipient.
